(19) United States
(12) Patent Application Publication
(10) Pub. No.: US 2017/0053041 A1
(43) Pub. Date: Feb. 23, 2017

(54) NUMBER-OF-BENDING CALCULATION SYSTEM, NUMBER-OF-BENDING CALCULATION METHOD, AND NON-TRANSITORY COMPUTER READABLE MEDIUM

(71) Applicant: FUJI XEROX CO., LTD., Tokyo (JP)

(72) Inventor: Masanori YOSHIZUKA, Kanagawa (JP)

(73) Assignee: FUJI XEROX CO., LTD., Tokyo (JP)

(21) Appl. No.: 15/053,434

(22) Filed: Feb. 25, 2016

(30) Foreign Application Priority Data
Aug. 21, 2015 (JP) 2015-163305

(51) Int. Cl. G06F 17/50

(52) U.S. Cl. CPC G06F 17/50

(57) ABSTRACT

A number-of-bending calculation system includes a memory in which information regarding a three-dimensional shape of an item is stored, a determining unit that determines, on a basis of a fact that a direction in which each surface that forms the three-dimensional shape of the item is bent with respect to an adjacent surface is a mountain-fold direction or a valley-fold direction, the number of times a mountain fold is made and the number of times a valley fold is made between a surface that functions as a reference surface and each of the surfaces, and a calculating unit that calculates, on a basis of number of bending for each of the surfaces that has been determined by the determining unit, a minimum number of bending for bending a flat plate into the shape of the item.

### CROSS-REFERENCE TO RELATED APPLICATION

This application is based on and claims priority under 35 USC 119 from Japanese Patent Application No. 2015-163305 filed Aug. 21, 2015.

### BACKGROUND

(i) Technical Field

The present invention relates to a number-of-bending calculation system, a number-of-bending calculation method, and a non-transitory computer readable medium.

(ii) Related Art

In the related art, designing of components included in mechanical products and the like has been performed by using a design support system, such as a three-dimensional computer-aided design system.

### SUMMARY

According to an aspect of the invention, there is provided a number-of-bending calculation system including a memory in which information regarding a three-dimensional shape of an item is stored, a determining unit that determines, on a basis of a fact that a direction in which each surface that forms the three-dimensional shape of the item is bent with respect to an adjacent surface is a mountain-fold direction or a valley-fold direction, the number of times a mountain fold is made and the number of times a valley fold is made in order to make between a surface that functions as a reference surface and each of the surfaces, and a calculating unit that calculates, on a basis of the number of bending for each of the surfaces that has been determined by the determining unit, a minimum number of bending for bending a flat plate into the shape of the item.

### BRIEF DESCRIPTION OF THE DRAWINGS

Exemplary embodiments of the present invention will be described in detail based on the following figures, wherein:

FIG. 1 is an overall view of a design support system according to an exemplary embodiment of the present invention;

FIG. 2 is a functional block diagram illustrating each function of a controller of a client personal computer according to the exemplary embodiment;

FIG. 3 is a diagram illustrating an example of a three-dimensional shape of an item according to the exemplary embodiment;

FIGS. 4A to 4D are tables each showing the number of times bending is performed for end surfaces, and FIG. 4A, FIG. 4B, FIG. 4C, and FIG. 4D are respectively a table showing bending patterns of the end surfaces, a table showing corresponding relationships between a bending pattern of “downward, upward, upward, and downward” and the bending patterns of the end surfaces, a table showing corresponding relationships between a bending pattern of “downward, upward, downward, and upward” and the bending patterns of the end surfaces, and a table showing corresponding relationships between a bending pattern of “upward, downward, upward, and downward” and the bending patterns of the end surfaces;

FIGS. 5A to 5C are lists showing all the bending patterns, and FIG. 5A, FIG. 5B, and FIG. 5C are respectively a list showing all the bending patterns when a maximum number of bending is 3, a list showing the bending patterns of the item illustrated in FIG. 3, and a list showing all the bending patterns when the maximum number of bending is 4; and

FIG. 6 is a flowchart of number-of-bending calculation processing in a design support program according to the exemplary embodiment of the present invention.

### DETAILED DESCRIPTION

A specific example of an exemplary embodiment of the present invention (hereinafter referred to as exemplary embodiment) will now be described with reference to the drawings. However, the present invention is not limited to the following exemplary embodiment.

Note that, in the following description, which refers to the drawings, descriptions of components that are not necessarily illustrated are suitably omitted for ease of understanding of the following description.

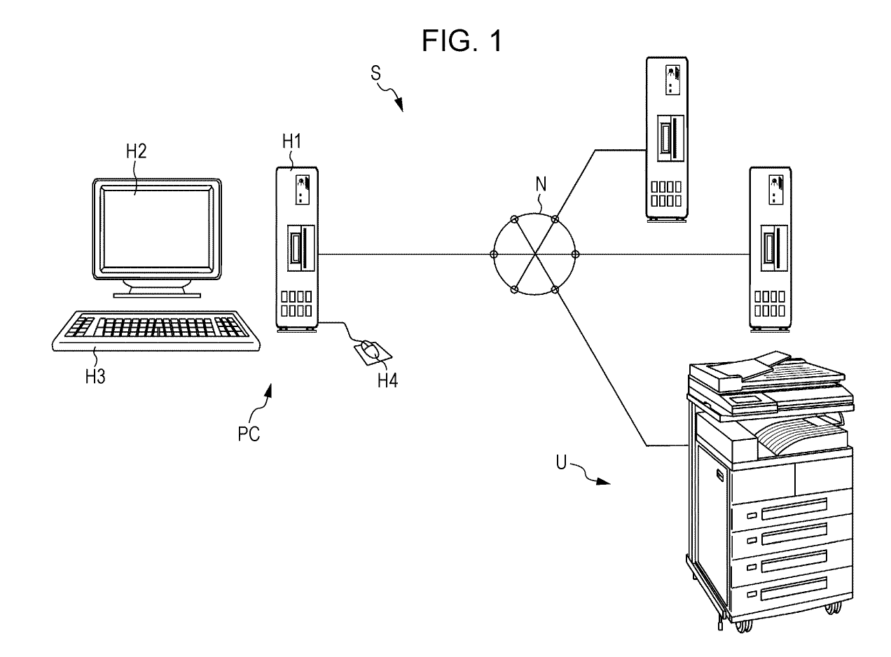

FIG. 1 is an overall view of a design support system according to an exemplary embodiment of the present invention.

In FIG. 1, a design support system S according to the exemplary embodiment has a function of serving as a number-of-bending calculation system. The design support system S includes a client personal computer PC, which is an example of a design support apparatus. The client personal computer PC has a function of serving as a number-of-bending calculation apparatus. The client personal computer PC is connected to a printer U, which is an example of an image forming apparatus, other servers, and the like via a network N, which is an example of a communication line.

Note that the network N according to the exemplary embodiment is formed of the so-called Internet line. The client personal computer PC according to the exemplary embodiment is formed of a computer apparatus, which is an example of an electronic calculator.

The client personal computer PC according to the exemplary embodiment includes a computer body H1, which is an example of a calculator body. A display H2, which is an example of a display device, is connected to the computer body H1. In addition, a keyboard H3 and a mouse H4, each of which is an example of an input device, are connected to the computer body H1. The computer body H1 includes a hard disk drive (HD drive), which is an example of a memory device (not illustrated), and a compact disc drive (CD drive), which is an example of a reading device that reads a storage medium.

### (Description of Controller of Exemplary Embodiment)

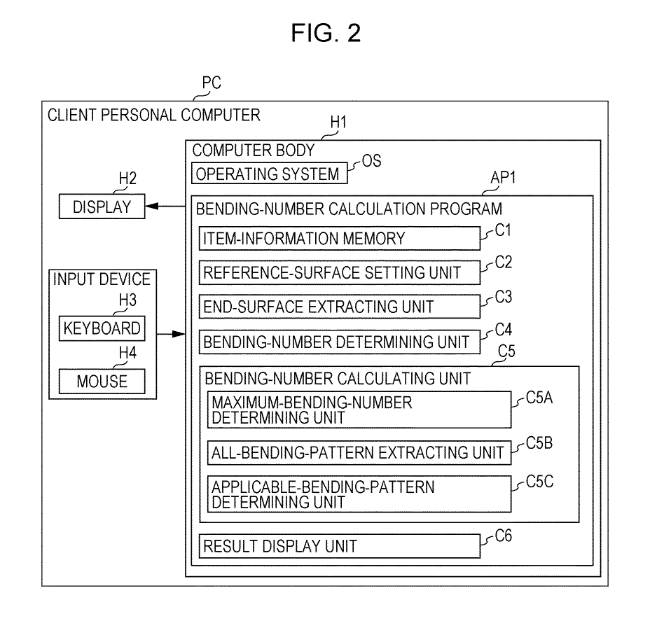

FIG. 2 is a functional block diagram illustrating each function of a controller of the client personal computer PC according to the exemplary embodiment.

### (Description of Controller of Client Personal Computer PC)

In FIG. 2, the computer body H1 of the client personal computer PC includes an input/output (I/O) interface. The I/O interface inputs and outputs signals to and from the outside and performs signal level adjustment of input/output signals and the like. The computer body H1 further includes a read only memory (ROM). Programs, data, and the like for performing necessary processing are stored in the ROM.

The computer body H1 further includes a random access memory (RAM). Necessary data is to be temporarily stored in the RAM. The computer body H1 further includes a central processing unit (CPU). The CPU performs processing according to programs stored in a hard disk and the like. The computer body H1 further includes a clock oscillator and the like.

The client personal computer PC may realize various functions by running the programs stored in the hard disk, the ROM, and the like.

An operating system OS, which is a basic software, is stored in the hard disk of the client personal computer PC. The operating system OS controls the basic operation of the computer apparatus.

In addition, a design support program AP1, which is an example of a number-of-bending calculation program, is stored in the hard disk of the client personal computer PC. Furthermore, a word-processing software (not illustrated), which is a document-preparation software, an application program, such as a software designed for transmitting and receiving electronic mail, and the like are stored in the hard disk of the client personal computer PC.

Each function (controller) of the design support program AP1 excluding the operating system OS, which is known in the related art, and the application program, which is not illustrated, will be described below.

### (Number-of-Bending Calculation Program AP1)

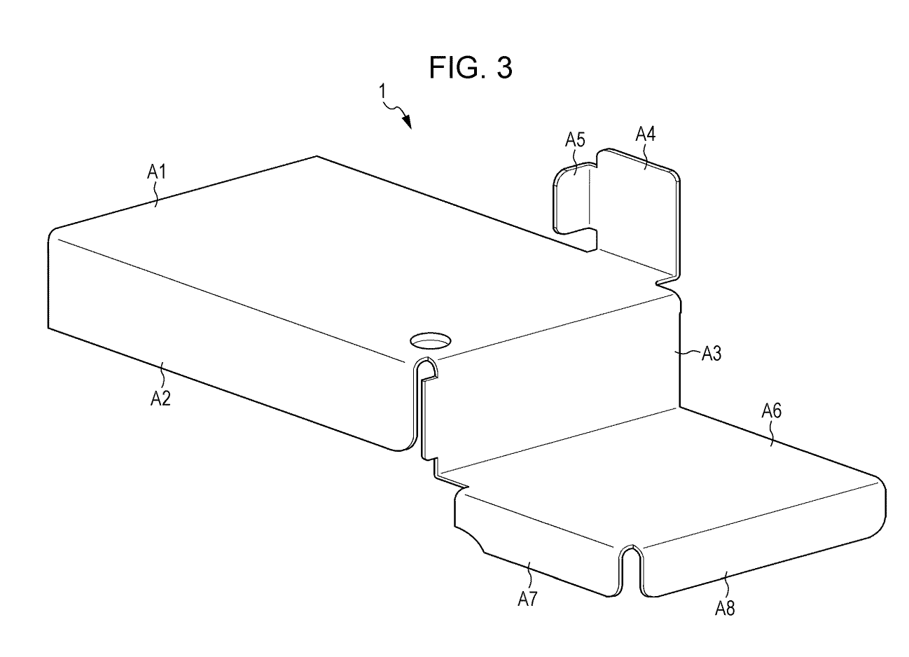

FIG. 3 is a diagram illustrating an example of the three-dimensional shape of an item according to the exemplary embodiment.

### C1: Item Information Memory

Information regarding the three-dimensional shape of an item 1 is stored in an item information memory C1. In the case of the item 1, which is illustrated in FIG. 3 as an example, the areas B1 to B8 of surfaces (portions each having a flat plate-like shape) A1 to A8 of the item 1, the shapes of the surfaces A1 to A8, the positions of the surfaces A1 to A8, and information indicating whether the connection between each of the surfaces A1 to A8 and its adjacent surface is formed by making a mountain fold or a valley fold are stored in the item information memory C1 according to the exemplary embodiment.

### C2: Reference-Surface Setting Unit

A reference-surface setting unit C2 sets a reference surface that is used as a basis for calculating the number of times bending is performed. In the item 1 that is a target for the number-of-bending calculation, one of the surfaces A1 to A8 that have the areas B1 to B8, respectively, the one surface having the largest area, is set as the reference surface by the reference-surface setting unit C2 according to the exemplary embodiment. In the item 1, which is illustrated in FIG. 3 as an example, the surface A1 having the area B1, which is the largest area, is set as the reference surface.

### C3: End-Surface Extracting Unit

An end-surface extracting unit C3 extracts, from the surfaces A1 to A8, which form the three-dimensional shape of the item 1, end surfaces A2, A5, A7, and A8, each of which is connected to one adjacent surface by a bend line. That is to say, the end-surface extracting unit C3 extracts the surfaces each having only one bend line connected to an adjacent surface as the end surfaces A2, A5, A7, and A8. Accordingly, in the item 1, which is illustrated in FIG. 3 as an example, the surfaces A2, A5, A7, and A8 are extracted as the end surfaces.

### C4: Number-of-Bending Determining Unit

A number-of-bending determining unit C4 determines, on the basis of a fact that a direction in which each of the surfaces A1 to A8, which form the three-dimensional shape of the item 1, is bent with respect to its adjacent surface is a mountain-fold direction or a valley-fold direction, the number of times the mountain fold is made and the number of times the valley fold is made between the surface A1, which is the reference surface, and each of the surfaces A2 to A8. The number-of-bending determining unit C4 according to the exemplary embodiment determines the number of times the mountain fold is made and the number of times the valley fold is made between from the surface A1, which is the reference surface, and each of the end surfaces A2, A5, A7, and A8. In other words, in the exemplary embodiment, the number-of-bending determining unit C4 determines only the number of bending for each of the end surfaces A2, A5, A7, and A8 instead of determining the number of bending for each of all the surfaces A2 to A8.

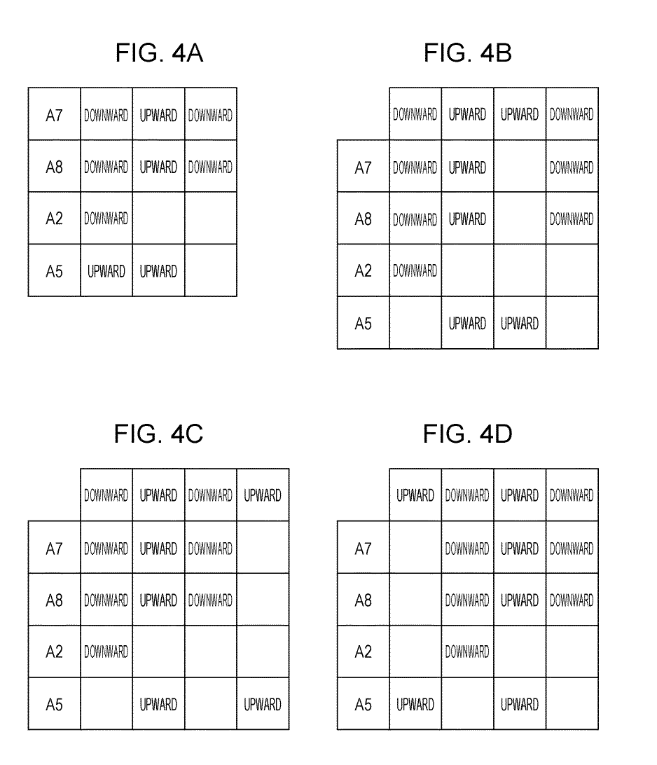

FIGS. 4A to 4D are tables each showing the number of times bending is performed for the end surfaces, and FIG. 4A, FIG. 4B, FIG. 4C, and FIG. 4D are respectively a table showing bending patterns of the end surfaces A2, A5, A7, and A8, a table showing corresponding relationships between a bending pattern of “downward, upward, upward, and downward” and the bending patterns of the end surfaces A2, A5, A7, and A8, a table showing corresponding relationships between a bending pattern of “downward, upward, downward, and upward” and the bending patterns of the end surfaces A2, A5, A7, and A8, and a table showing corresponding relationships between a bending pattern of “upward, downward, upward, and downward” and the bending patterns of the end surfaces A2, A5, A7, and A8.

In FIG. 4A, in the case of the item 1, which is illustrated in FIG. 3 as an example, the end surface A2 may be formed by making a mountain fold with the reference surface A1, that is, by bending the end surface A2 downward with respect to the reference surface A1. Similarly, the end surface A5 may be formed by making a valley fold (“upward bending”) twice with the reference surface A1. The end surfaces A7 and A8 may each be formed by making a mountain fold, a valley fold, and another mountain fold in this order with the reference surface A1.

### C5: Number-of-Bending Calculating Unit

A number-of-bending calculating unit C5 includes a maximum-number-of-bending determining unit C5A, an all-bending-pattern extracting unit C5B, and an applicable-pattern determining unit C5C. The number-of-bending calculating unit C5 calculates, on the basis of the number of bending for each of the surfaces A2, A5, A7, and A8, which has been determined by the number-of-bending determining unit C4, a minimum number of bending N2 for bending a flat plate into the shape of the item 1. In the exemplary embodiment, the minimum number of bending N2 is calculated on the basis of the number of bending for each of the end surfaces A2, A5, A7, and A8.

### C5A: Maximum-Number-of-Bending Determining Unit

The maximum-number-of-bending determining unit C5A determines, as a maximum number of bending N1, the largest total number of bending among the total numbers of bending for the end surfaces A2, A5, A7, and A8, the total numbers of bending having been determined by the number-of-bending determining unit C4. Each of the total numbers of bending is the total number of times the mountain fold is made and the number of times the valley fold is made for the corresponding one of the end surfaces A2, A5, A7, and A8. In the item 1, which is illustrated in FIG. 3 as an example, since each of the total numbers of bending for the end surfaces A7 and A8 is 3, the maximum number of bending N1 is determined to be 3.

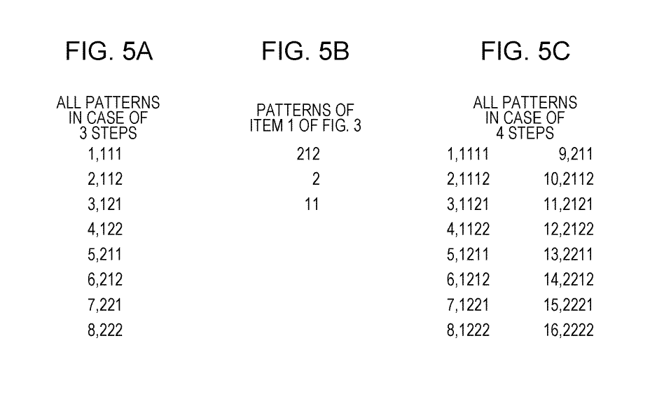

FIGS. 5A to 5C are lists showing all the bending patterns, and FIG. 5A, FIG. 5B, and FIG. 5C are respectively a list showing all the bending patterns when the maximum number of bending N1 is 3, a list showing the bending patterns of the item 1 illustrated in FIG. 3, and a list showing all the bending patterns when the maximum number of bending N1 is 4.

### C5B: All-Bending-Pattern Extracting Unit

The all-bending-pattern extracting unit C5B extracts all the bending patterns, each of which is a combination of a mountain fold and a valley fold, on the basis of the maximum number of bending N1. In FIGS. 5A to 5C, the valley fold and the mountain fold are represented by “1” and respectively, and in the case where the maximum number of bending N1 is 3, all the bending patterns have eight types as shown in FIG. 5A. In the case where the maximum number of bending N1 is 4, all the bending patterns have 16 types as shown in FIG. 5C. Note that, regarding the item 1 illustrated in FIG. 3, the bending patterns of the end surfaces A2, A5, A7, and A8 have three types as shown in FIG. 5B in the above notation.

### C5C: Applicable-Pattern Determining Unit

The applicable-pattern determining unit C5C determines an applicable pattern, which is a bending pattern including all the bending patterns of the end surfaces A2, A5, A7, and A8 of the item 1, among all the bending patterns, which have been extracted by the all-bending-pattern extracting unit C5B. As shown in FIG. 5A, in the case where the maximum number of bending N1 is 3, only the pattern 6 includes the bending patterns “212” of the end surfaces A7 and A8; the pattern 6 does not include the bending pattern “11” of the end surface A5. Thus, in the case where the maximum number of bending N1 is 3, the applicable-pattern determining unit C5C according to the exemplary embodiment determines that “there is no applicable pattern”. Then, the applicable-pattern determining unit C5C determines whether there is an applicable pattern in the case where the maximum number of bending N1 is 4.

As shown in FIG. 5C, in the case where the maximum number of bending N1 is 4, the applicable-pattern determining unit C5C determines that the patterns 6, 10, 11, 12, and 14 include the bending pattern “212” of the end surfaces A7 and A8. Note that, in FIG. 5C, when one of the patterns includes the numbers “2”, “1”, and “2” that appear in this order in the left-to-right direction, as in the pattern 10 “2112” and the pattern 11 “2121”, the applicable-pattern determining unit C5C determines that the bending pattern “212” of the end surfaces A7 and A8 is included in the pattern even if there are other numbers between the numbers “2”, “1”, and “2”, or even if extra numbers are added to positions before and after the numbers and “2”. Since the numbers “1” and “1” appear in this order in the patterns 6, 10, and 11, the applicable-pattern determining unit C5C determines that the bending pattern “11” of the end surface A5 is included in the patterns 6, 10, and 11. In addition, the applicable-pattern determining unit C5C determines that the bending pattern “2” of the end surface A2 is also included in the patterns 6, 10, and 11. Accordingly, in the case of the item 1, which is illustrated in FIG. 3 as an example, each of the patterns 6, 10, and 11 in FIG. 5C is determined to be the applicable pattern, which includes all the bending patterns of the item 1. Therefore, in the case of the pattern 6, the bending patterns of the end surfaces A2, A5, A7, and A8 correspond to the bending patterns shown in FIG. 4D. In the case of the pattern 10, the bending patterns of the end surfaces A2, A5, A7, and A8 correspond to the bending patterns shown in FIG. 4B. In the case of the pattern 11, the bending patterns of the end surfaces A2, A5, A7, and A8 correspond to the bending patterns shown in FIG. 4C. Note that, in this case, the number-of-bending calculating unit C5 calculates that the minimum number of bending N2 is 4.

### C6: Result Display Unit

A result display unit C6 causes the minimum number of bending N2, which has been calculated by the number-of-bending calculating unit C5, to be displayed on the display H2. In addition to the minimum number of bending N2, the result display unit C6 according to the exemplary embodiment also causes an applicable pattern to be displayed on the display H2. Note that, in the actual process, all the surfaces are sequentially processed starting not from the reference surface A1 but from the end surfaces A2, A5, A7, and A8, and thus, from the standpoint of enabling an operator to visually recognize the bending process easily, when causing a pattern to be displayed on the display H2, the pattern may be displayed by reversing the order of the numbers included in the pattern so as to conform to the processing order. That is to say, in the case of the pattern 6, the order of the numbers will be “2121”, in the case of the pattern 10, the order of the numbers will be “2112”, and in the case of the pattern 11, the order of the numbers will be “1212”.

### (Description of Flowchart of Exemplary Embodiment)

The flow of process in the design support program AP1 of the client personal computer PC according to the exemplary embodiment will now be described by using a flowchart.

### (Description of Flowchart of Process in Design Support Program AP1 of Exemplary Embodiment)

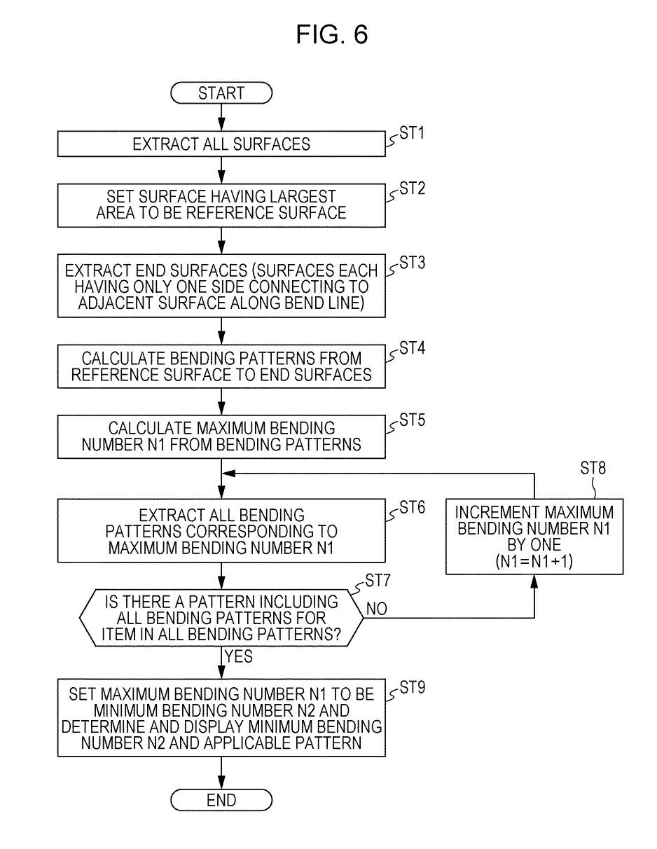

FIG. 6 is a flowchart of number-of-bending calculation processing in the design support program AP1 according to the exemplary embodiment of the present invention.

The process of steps in the flowchart of FIG. 6 is executed in accordance with the programs stored in the ROM and the like of the controller. In addition, the process is executed in parallel with other various processing (e.g., drawing processing for a molded product and the like) performed by the controller in a multitasking manner.

The design support program AP1 starts executing the process illustrated in the flowchart of FIG. 6 once the design support program AP1 has received an input of an instruction to start number-of-bending calculation.

In ST1 of FIG. 6, all the surfaces A1 to A8 of the item 1 are extracted. Then, the process proceeds to ST2.

In ST2, the surface A1 having the largest area among the extracted surfaces A1 to A8 is set to be a reference surface. Then, the process proceeds to ST3.

In ST3, the end surfaces A2, A5, A7, and A8 are extracted. Then, the process proceeds to ST4.

In ST4, bending patterns between the reference surface A1 and the end surfaces A2, A5, A7, and A8 are calculated. Then, the process proceeds to ST5.

In St5, the maximum number of bending N1 is calculated from the bending patterns. Then, the process proceeds to ST6.

In ST6, all the bending patterns corresponding to the maximum number of bending N1 are extracted. Then, the process proceeds to ST7.

In ST7, it is determined whether there is a bending pattern that includes all the bending patterns of the end surfaces A2, A5, A7, and A8 of the item 1 among all the bending patterns. In the case where the determination result is No (N), the process proceeds to ST8, and in the case where the determination result is Yes (Y), the process proceeds to ST9.

In ST8, the maximum number of bending N1 is incremented by 1. In other words, N1=N1+1 is set. Then, the process returns to ST6.

In ST9, the maximum number of bending N1 is set to be the minimum number of bending N2, and the minimum number of bending N2 and an applicable pattern are determined and displayed on the display H2. Finally, the number-of-bending calculation processing is finished.

### (Function of Design Support Program AP1)

In the design support system S according to the exemplary embodiment, which has the above-described configuration, upon running the design support program AP1, the surface A1 that has the largest area B1 among all the surfaces A1 to A8 of the item 1 is set to be the reference surface. Subsequently, the bending patterns from the reference surface A1 to the end surfaces A2, A5, A7, and A8 of the item 1 are calculated. Then, an applicable pattern that includes all the bending patterns is determined, and the minimum number of bending N2 is calculated.

In the exemplary embodiment, the surface A1, which has the largest area B1, is set to be the reference surface. From the standpoint of facilitating bending, when performing bending, the other surfaces may be bent while using the surface A1, which has a large area, as a reference in a state where the surface A1 is held. Accordingly, in the exemplary embodiment, a surface that is highly likely to function as a reference during bending is set to be the reference surface, and an applicable pattern is determined. Therefore, in the exemplary embodiment, a surface that is highly likely to be used as a reference surface during the actual bending process is automatically set to be the reference surface.

In addition, in the exemplary embodiment, in the case where there are plural applicable patterns, each of the applicable patterns is displayed on the display H2.

### (Modifications)

Although the exemplary embodiment of the present invention has been described in detail above, the present invention is not limited to the above-described exemplary embodiment, and various changes may be made within the scope of the present invention as described in the claims. Modifications (H01) to (H06) of the present invention will now be described below as examples.

(H01) Although the configuration in which an applicable pattern is determined and displayed in addition to the minimum number of bending N2 has been described in the above-described exemplary embodiment as an example, the present invention is not limited to this. If deemed unnecessary, the function of determining and displaying an applicable pattern may be omitted so that the design support program AP1 may have only the function of determining and displaying the minimum number of bending N2. Alternatively, only an applicable pattern may be determined.

(H02) In the above-described exemplary embodiment, although it is desirable that the targets for extracting bending patterns be the end surfaces A2, A5, A7, and A8, a configuration in which bending patterns of all the surfaces are calculated may be employed.

(H03) In the above-described exemplary embodiment, the item 1 is not limited to the configuration illustrated in FIG. 3 as an example, and the present invention may be applied to an arbitrary item having a three-dimensional shape.

(H04) Although the configuration in which a surface having the largest area is automatically set to be a reference surface has been described in the above-described exemplary embodiment as an example, the present invention is not limited to this. A configuration in which a reference surface is manually set by a user may be employed. Alternatively, any changes may be made, and for example, other conditions other than the areas may be used in such a manner that one of the end surfaces is set to be a reference surface. Alternatively, a configuration may be employed in which both the automatic setting using the areas or the like and the manual setting are available.

(H05) Although the configuration in which, in the case where there are plural applicable patterns, all the applicable patterns are displayed on the display H2 has been described in the above-described exemplary embodiment as an example, the present invention is not limited to this. For example, a configuration in which determination is performed under additional conditions, such as by not making the mountain fold and the valley fold in series, so that the applicable patterns are narrowed down to one, and the one applicable pattern is displayed may be employed.

(H06) Although the configuration in which the item information memory C1 and the number-of-bending calculating unit C5 are incorporated within one client personal computer has been described in the above-described exemplary embodiment as an example, the present invention is not limited to this. For example, a configuration in which the item information memory C1 is included in a data server that is connected to the client personal computer PC via the network N, and the processing to be performed by the units C2 to C5 is performed by one or more than one terminal on the network N, that is, a configuration in which distributed processing is performed via the network N may be employed. Alternatively, a configuration in which the processing is performed only by another terminal on the network N, and the client personal computer PC only displays the results or a configuration similar to that of a thin client may be employed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A number-of-bending calculation system comprising:
a memory in which information regarding a three-dimensional shape of an item is stored;
a determining unit that determines, on a basis of a fact that a direction in which each surface that forms the three-dimensional shape of the item is bent with respect to an adjacent surface is a mountain-fold direction or a valley-fold direction, the number of times a mountain fold is made and the number of times a valley fold is made between a surface that functions as a reference surface and each of the surfaces; and
a calculating unit that calculates, on a basis of the number of bending for each of the surfaces that has been determined by the determining unit, a minimum number of bending for bending a flat plate into the shape of the item.

2. The number-of-bending calculation system according to claim 1,
wherein one of the surfaces that form the three-dimensional shape of the item, the one surface having the largest area, is set to be the reference surface.

3. The number-of-bending calculation system according to claim 1, further comprising:
an end-surface extracting unit that extracts, from the surfaces that form the three-dimensional shape of the item, end surfaces each of which is a surface connected to only one adjacent surface to the end surface by a bend line,
wherein the determining unit determines the number of times the mountain fold is made and the number of times the valley fold is made between the reference surface and each of the end surfaces.

4. The number-of-bending calculation system according to claim 2, further comprising:
an end-surface extracting unit that extracts, from the surfaces that form the three-dimensional shape of the item, end surfaces each of which is a surface connected to one adjacent surface by a bend line,
wherein the determining unit determines the number of times the mountain fold is made and the number of times the valley fold is made between the reference surface and each of the end surfaces.

5. A number-of-bending calculation method comprising:
storing information regarding a three-dimensional shape of an item;
determining, on a basis of a fact that a direction in which each surface that forms the three-dimensional shape of the item is bent with respect to an adjacent surface is a mountain-fold direction or a valley-fold direction, the number of times a mountain fold is made and the number of times a valley fold is made between a surface that functions as a reference surface and each of the surfaces; and
calculating, on a basis of the number of bending for each of the surfaces that has been determined by the determining unit, a minimum number of bending for bending a flat plate into the shape of the item.

6. A non-transitory computer readable medium storing a program causing a computer to perform a process, the process comprising:
storing information regarding a three-dimensional shape of an item;
determining, on a basis of a fact that a direction in which each surface that forms the three-dimensional shape of the item is bent with respect to an adjacent surface is a mountain-fold direction or a valley-fold direction, the number of times a mountain fold is made and the number of times a valley fold is made between a surface that functions as a reference surface and each of the surfaces; and
calculating, on a basis of number of bending for each of the surfaces that has been determined by the determining unit, a minimum number of bending for bending a flat plate into the shape of the item.
